(19) United States
(12) Patent Application Publication
(10) Pub. No.: US 2019/0152072 A1
(43) Pub. Date: May 23, 2019

(54) Robot

(71) Applicant: Seiko Epson Corporation, Tokyo (JP)

(72) Inventors: Takema YAMAZAKI, Fujimi (JP); Takashi KOJIMA, Matsumoto (JP)

(21) Appl. No.: 16/194,728

(22) Filed: Nov. 19, 2018

(30) Foreign Application Priority Data
Nov. 20, 2017 (JP) 2017-222633

(51) Int. Cl. B25J 19/00; B25J 9/16

(52) U.S. Cl. CPC B25J 19/0029; B25J 19/0054; B25J 9/16

(57) ABSTRACT

A robot includes a motor and a power supply section configured to supply electric power to the motor. The power supply section includes a first power supply circuit and a second power supply circuit and is located on the inside of the robot.

### BACKGROUND

### 1. Technical Field

The present invention relates to a robot.

### 2. Related Art

Researches and developments of a control device that controls a robot have been conducted.

In relation to the researches and developments, there is known a robot controlled by an externally attached control device (see JP-A-2011-177845 (Patent Literature 1)).

When the robot is controlled by the externally attached control device, in some case, a setting area (a footprint) for disposing the robot and the control device is large and a setting place is limited. When a robot is controlled by a control device incorporated in the robot, the setting area is small. However, in this case, a deficiency sometimes occurs in a part of the robot and the control device because of heat emitted from a heat source part among parts of the control device on the inside of the robot.

### SUMMARY

An aspect of the invention is directed to a robot including: a driving section; and a power supply section configured to supply electric power to the driving section. The power supply section includes a first power supply circuit and a second power supply circuit and is located on an inside of the robot.

With this configuration, the robot can prevent an increase in a setting area and prevent a temperature rise of the power supply section.

In another aspect of the invention, the robot may be configured such that a first input circuit and a first output circuit included in the first power supply circuit are electrically isolated, a second input circuit and a second output circuit included in the second power supply circuit are electrically isolated, an output terminal on a high-potential side of output terminals of the first output circuit and an output terminal on a low-potential side of output terminals of the second output circuit are connected, and the power supply section applies, between an output terminal on a low-potential side of the output terminals of the first output circuit and an output terminal on a high-potential side of the output terminals of the second output circuit, a voltage obtained by adding up an output voltage of the first output circuit and an output voltage of the second output circuit.

With this configuration, the robot can supply desired electric power to the driving section while preventing a temperature rise of the power supply section.

In another aspect of the invention, the robot may be configured such that a rated output power value of the first power supply circuit is equal to a rated output power value of the second power supply circuit.

With this configuration, the robot can supply electric power to the driving section with the first power supply circuit and the second power supply circuit while preventing a deficiency from occurring in at least one of the first power supply circuit and the second power supply circuit because of a difference between the rated output power values of the first power supply circuit and the second power supply circuit.

In another aspect of the invention, the robot may be configured such that an output voltage of the first power supply circuit is equal to an output voltage of the second power supply circuit.

With this configuration, the robot can supply electric power to the driving section with the first power supply circuit and the second power supply circuit while preventing a deficiency from occurring in at least one of the first power supply circuit and the second power supply circuit because of a difference between the output voltages of the first power supply circuit and the second power supply circuit.

In another aspect of the invention, the robot may be configured such that at least one of the first input circuit and the second input circuit includes a harmonic current suppression circuit.

With this configuration, the robot can suppress noise that occurs in at least one of the first power supply circuit and the second power supply circuit.

In another aspect of the invention, the robot may be configured such that the robot further includes a power converting section configured to convert electric power supplied from the power supply section into electric power supplied to the driving section.

With this configuration, the robot can drive the driving section with electric power supplied by both of the first power supply circuit and the second power supply circuit and converted by the power converting section.

In another aspect of the invention, the robot may be configured such that the power supply section is capable of supplying, in a predetermined time, electric power having a power value not less than 1.1 times and not more than four times of a rated output power value.

With this configuration, the robot can supply, to the driving section, electric power necessary for starting to turn the driving section in the robot.

### BRIEF DESCRIPTION OF THE DRAWINGS

The invention will be described with reference to the accompanying drawings, wherein like numbers reference like elements.

FIG. 1 is a diagram showing an example of the configuration of a robot according to an embodiment.

FIG. 2 is a diagram showing a connection state of a power supply section and a power converting section.

FIG. 3 is a diagram showing an example of a relation between a temperature change around a power supply section and a change in an allowable load factor of the power supply section at the time when natural air cooling is adopted as a cooling method for the power supply section.

FIG. 4 is a diagram showing an example of a relation between a temperature change around the power supply section and a change in an allowable load factor of the power supply section at the time when forced air cooling is adopted as the cooling method for the power supply section.

### DESCRIPTION OF EXEMPLARY EMBODIMENTS

### Embodiment

An embodiment of the invention is explained below with reference to the drawings.

### Configuration of a Robot

First, the configuration of a robot 1 is explained.

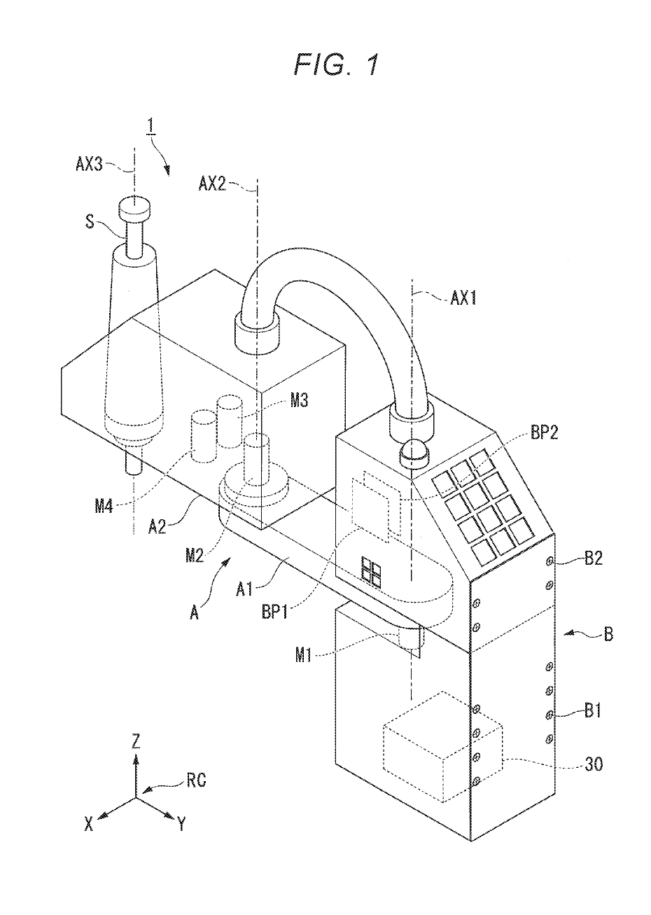

FIG. 1 is a diagram showing an example of the configuration of the robot 1 according to the embodiment. The robot 1 is, for example, a SCARA (horizontal articulated) robot. The robot 1 may be other robots such as a vertical articulated robot and a Cartesian coordinate robot instead of the SCARA robot. The vertical articulated robot may be a single arm robot including one arm, may be a double arm robot including two arms (a plural arm robot including two arms), or may be a plural arm robot including three or more arms. The Cartesian coordinate robot is, for example, a gantry robot.

The robot 1 includes a base B set on a setting surface and a movable section A supported by the base B. The setting surface refers to a surface on which the robot 1 is set such as a floor surface of a room in which the robot 1 is set, a wall surface of the room, a ceiling surface of the room, the outdoor ground, an upper surface of a table, or an upper surface of a stand.

The base B is configured from two parts. One of the parts is a first base B1 and the other is a second base B2. A space on the inner side of the first base B1 is connected to a space on the inner side of the second base B2.

The first base B1 is set on the setting surface. The first base B1 has a substantially rectangular parallelepiped (or cubic) shape as an external shape. The first base B1 is configured from tabular surfaces and is hollow. The second base B2 is fixed to a first upper surface, which is a part of the upper surface of the first base B1. The upper surface is a surface on the opposite side of the setting surface among the surfaces of the first base B1. The distance between a second upper surface, which is a portion other than the first upper surface of the upper surface of the first base B1, and the setting surface is short compared with the distance between the first upper surface and the setting surface. Therefore, a gap is present between the second upper surface and the second base B2. The movable section A is provided on the second upper surface. That is, the first base B1 supports the movable section A. The shape of the first base B1 may be another shape instead of such a shape if the other shape is a shape that enables the second base B2 to be fixed to a part of the upper surface of the first base B1.

The second base B2 has, as an external shape, a shape obtained by cutting off, in a direction perpendicular to two surfaces opposed to each other configuring a rectangular parallelepiped (or a cube), a triangular portion including one vertex in each of the two surfaces to be removed. The shape obtained by cutting off the portion may be not always formed by machining for cutting off the portion and may be formed by, for example, machining for forming the same shape from the beginning. The second base B2 has such a polyhedron shape as the external shape. The second base B2 is configured from tabular surfaces and is hollow. The shape of the second base B2 may be another shape instead of such a shape if the other shape is a shape that enables the second base B2 to be fixed to a part of the upper surface of the first base B1.

The movable section A includes a first arm A1 supported turnably around a first turning axis AX1 by the base B, a second arm A2 supported turnably around a second turning axis AX2 by the first arm A1, and a shaft S supported turnably around a third turning axis AX3 and translatably in the axial direction of the third turning axis AX3 by the second arm A2.

The shaft S is a columnar shaft body. A not-shown ball screw groove and a not-shown spline groove are respectively formed on the circumferential surface of the shaft S. In this example, the shaft S is provided to pierce through an end portion on the opposite side of the first arm A1 of end portions of the second arm A2 in a first direction, which is a direction in which the base B is set on the setting surface and is a direction perpendicular to the setting surface. The first direction is, for example, a direction along a Z axis in a robot coordinate system RC shown in FIG. 1. The first direction may be a direction not along the Z axis instead of the direction along the Z axis. An end effector can be attached to an end portion on the setting surface side of end portions of the shaft S. The end effector may be an end effector capable of holding an object with finger sections, may be an end effector capable of holding an object with attraction or the like by the air or magnetism, or may be other end effectors. In this embodiment, “holding the object” means “bringing the object into a state in which the object can be lifted”.

In this example, the first arm A1 turns around the first turning axis AX1 and moves in a second direction. The second direction is a direction orthogonal to the first direction. The second direction is, for example, a direction along an XY plane, which is a plane formed by an X axis and a Y axis in the robot coordinate system RC. The second direction may be a direction not along the XY plane instead of the direction along the XY plane.

The first arm A1 is turned (driven) around the first turning axis AX1 by a driving section M1 included in the base B. That is, in this example, the first turning axis AX1 is an axis coinciding with a driving axis of the driving section M1. The first turning axis AX1 and the driving axis of the driving section M1 may not coincide with each other. In this case, for example, the driving section M1 turns the first arm A1 around the first turning axis AX1 with, for example, a method of turning the first arm A1 using a pulley and a belt.

In this example, the second arm A2 turns around the second turning axis AX2 and moves in the second direction. The second arm A2 is turned around the second turning axis AX2 by a driving section M2 included in the second arm A2. That is, in this example, the second turning axis AX2 is an axis coinciding with a driving axis of the driving section M2. The second turning axis AX2 and the driving axis of the driving section M2 may not coincide with each other. In this case, for example, the driving section M2 turns the second arm A2 around the second turning axis AX2 with, for example, a method of turning the second arm A2 using a pulley and a belt.

The second arm A2 includes a driving section M3 and a driving section M4 and supports the shaft S. The driving section M3 moves (lifts and lowers) the shaft S in the first direction by turning, with a timing belt or the like, a ball screw nut provided in the outer circumferential portion of the ball screw groove of the shaft S. The driving section M4 turns the shaft S around the third turning axis AX3 by turning, with a timing belt or the like, a ball spline nut provided in the outer circumferential portion of the spline groove of the shaft S.

In the following explanation, as an example, all of the driving sections M1 to M4 have the same configuration. In the following explanation, the driving sections M1 to M4 are collectively referred to as driving section M unless it is necessary to distinguish each of the driving sections M1 to M4. A part or all of the driving sections M1 to M4 may have configurations different from one another.

The driving section M is, for example, a servomotor. The driving section M may be another actuator driven by electricity. In this example, the driving section M is a servomotor configured integrally with each of an amplifier section including a driving circuit configured to drive a motor and an encoder configured to detect information indicating a turning angle of the driving section M. When driving the driving section M, the driving circuit performs switching control. The switching control is, for example, PWM (Pulse Width Modulation) control. The switching control may be other switching control instead of the PWM control. The driving section M may be configured separately from one or both of the amplifier section and the encoder.

The robot 1 is controlled by the control device 30. The robot 1 incorporates the control device 30 therein. The robot 1 may be controlled by the control device 30 externally attached to the robot 1.

The control device 30 is a controller configured to control the robot 1. The control device 30 controls each of the four driving sections M (i.e., the driving sections M1 to M4) and operates the robot 1. The control device 30 includes a power supply section EP and a power converting section IV for each of the four driving sections M.

In this example, portions other than each of the power supply section EP and the power converting section IV among portions of the control device 30 are located on the inner side of the first base B1 on the inside of the robot 1. In this example, the power supply section EP of the control device 30 is located on the inner side of the second base B2. The power converting section IV of the control device 30 may be provided in any position on the inside of the robot 1. The power converting section IV may be included in the driving section M, to which the power converting section IV supplies electric power, or may be included in another member included in the robot 1 instead of being included in the control device 30. In the example shown in FIG. 1, to prevent the figure from being complicated, illustration of the power supply section EP and the power converting section IV is omitted.

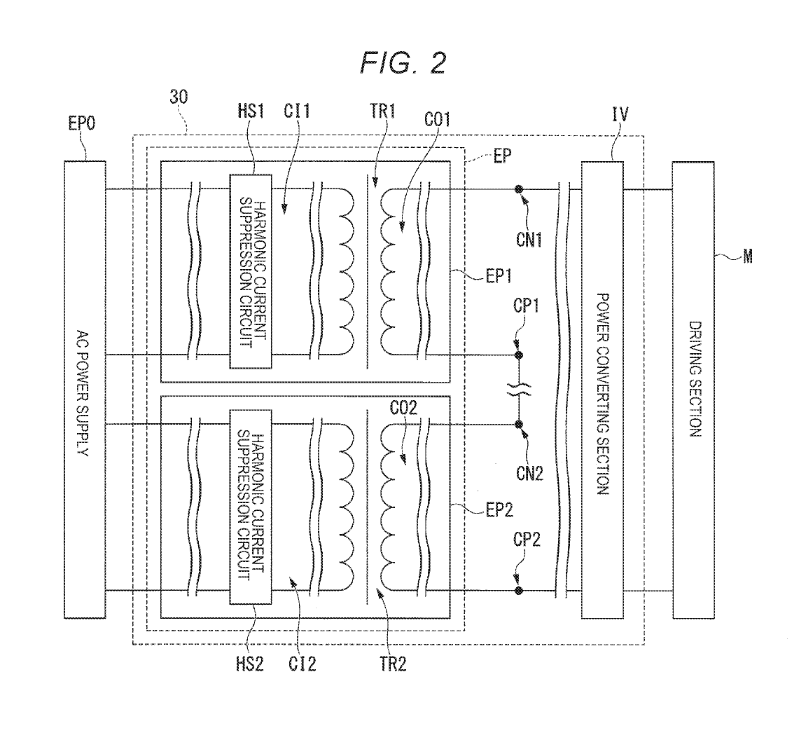

The power supply section EP and the power converting section IV are explained with reference to FIG. 2. FIG. 2 is a diagram showing an example of a connection state of the power supply section EP and the power converting section IV. In the following explanation, for convenience of explanation, electric energy is referred to as electric power and is referred to as power value when the electric energy indicates the magnitude of the electric power in particular.

The power supply section EP is provided on the inner side of the second base B2, that is, on the inside of the robot 1. Therefore, the power supply section EP is located on the inside. The power supply section EP supplies electric power to the driving section M. More specifically, the power supply section EP supplies electric power to the power converting section IV. The power converting section IV converts the electric power supplied from the power supply section EP into electric power supplied to the driving section M and supplies the converted electric power to the driving section M. That is, the power supply section EP supplies the electric power to the driving section M via the power converting section IV.

As shown in FIG. 2, the power supply section EP supplies electric power to the driving section M on the basis of AC power supplied from an AC power supply EP0. The AC power supply EP0 is, for example, a distribution board provided in a room in which the robot 1 is set. The AC power supply EP0 may be, instead of the distribution board, another AC power supply such as an outlet provided in the room in which the robot 1 is set.

The power supply section EP includes a first power supply circuit EP1 and a second power supply circuit EP2. More specifically, the power supply section EP includes two separate substrates, that is, a first substrate BP1 and a second substrate BP2 (see FIG. 1). The first power supply circuit EP1 is provided on the first substrate BP1. The second power supply circuit EP2 is provided on the second substrate BP2. The power supply section EP supplies electric power to the driving section M with both of the first power supply circuit EP1 and the second power supply circuit EP2. Consequently, the power supply section EP can disperse a heat value generated during the supply of the electric power to the driving section M. As a result, a temperature rise of the power supply section EP can be prevented. Since the first power supply circuit EP1 and the second power supply circuit EP2 are respectively provided on the two substrates in this way, the robot 1 can improve flexibility in disposing the power supply section EP on the inside of the robot 1. In the power supply section EP, the first power supply circuit EP1 and the second power supply circuit EP2 may be provided on one substrate instead of being respectively provided on the separate substrates. In this case, the distance between the first power supply circuit EP1 and the second power supply circuit EP2 are desirably larger. The first power supply circuit EP1 may be divided into and provided on a plurality of substrates instead of being provided on one first substrate BP1. The second power supply circuit EP2 may be divided into and provided on a plurality of substrates instead of being provided on one second substrate BP2.

The first power supply circuit EP1 includes a first input circuit CI1, an isolation transformer TR1, and a first output circuit CO1 electrically isolated from the first input circuit CI1 by the isolation transformer TR1. In this example, in the first power supply circuit EP1, the first input circuit CI1 and the first output circuit CO1 are electrically isolated by the isolation transformer TR1. However, the first input circuit CI1 and the first output circuit CO1 may be electrically isolated by another element instead of the isolation transformer TR1.

The first input circuit CI1 is a circuit on a primary side in the first power supply circuit EP1. The first input circuit CI1 includes a not-shown rectifier and a not-shown smoothing circuit and supplies the AC power supplied from the AC power supply EP0 to the isolation transformer TR1. The first input circuit CI1 may be any circuit if the circuit is capable of supplying the AC power to the isolation transformer TR1. In the example shown in FIG. 2, a harmonic current suppression circuit HS1 is included in the first input circuit CI1. The harmonic current suppression circuit HS1 may be any circuit if the circuit suppresses a harmonic current by shaping a waveform of an electric current rectified by the rectifier into a waveform close to a waveform of a sine wave. Consequently, the control device 30 can suppress noise that occurs in the first power supply circuit EP1. The harmonic current suppression circuit HS1 may not be included in the first input circuit CI1.

As explained above, the isolation transformer TR1 electrically isolates the first input circuit CI1 and the first output circuit C01. When the AC power is supplied from the first input circuit CI1, the isolation transformer TR1 outputs the AC power to the first output circuit C01.

The first output circuit CO1 is a circuit on a secondary side in the first power supply circuit EP1. The first output circuit CO1 includes a not-shown rectifier and a not-shown smoothing circuit and converts the AC power supplied from the isolation transformer TR1 into DC power. The first output circuit CO1 includes two output terminals, that is, an output terminal CP1 and an output terminal CN1. The output terminal CP1 is an output terminal on a high-potential side in the first output circuit C01. The output terminal CN1 is an output terminal on a low-potential side in the first output circuit C01.

When the AC power is supplied from the isolation transformer TR1, the first output circuit CO1 converts the supplied AC power into DC power and causes a potential difference corresponding to the converted DC power between the output terminal CP1 and the output terminal CN1. At this time, potential applied to the output terminal CP1 is higher than potential applied to the output terminal CN1. As explained above, the first output circuit CO1 is electrically isolated from the first input circuit CI1 by the isolation transformer TR1. Therefore, the first output circuit CO1 can be regarded as a battery including the output terminal CP1 as a plus terminal and including the output terminal CN1 as a minus terminal. That is, when the first output circuit CO1 is regarded as the battery, the first input circuit CI1 is equivalent to an electromotive force of the first output circuit C01, which is the battery. The first output circuit CO1 may be any circuit if the circuit is capable of causing a potential difference corresponding to the DC power supplied from the isolation transformer TR1 between the output terminal CP1 and the output terminal CN1.

The second power supply circuit EP2 includes a second input circuit CI2, an isolation transformer TR2, and a second output circuit CO2 electrically insulted from the second input circuit CI2 by the isolation transformer TR2. In this example, in the second power supply circuit EP2, the second input circuit CI2 and the second output circuit CO2 are electrically isolated by the isolation transformer TR1. Therefore, the second input circuit CI2 and the second output circuit CO2 may be electrically isolated by another element instead of the isolation transformer TR2.

The second input circuit CI2 is a circuit on a primary side in the second power supply circuit EP2. The second input circuit CI2 includes a not-shown rectifier and a not-shown smoothing circuit and supplies the AC power supplied from the AC power supply EP0 to the isolation transformer TR2. The second input circuit CI2 may be any circuit if the circuit is capable of supplying the AC power to the isolation transformer TR2. In the example shown in FIG. 2, a harmonic current suppression circuit HS2 is included in the second input circuit CI2. The harmonic current suppression circuit HS2 may be any circuit if the circuit suppresses a harmonic current by shaping a waveform of an electric current rectified by the rectifier into a waveform close to a waveform of a sine wave. Consequently, the control device 30 can suppress noise that occurs in the second power supply circuit EP2. The harmonic current suppression circuit HS2 may not be included in the second input circuit CI2.

As explained above, the isolation transformer TR2 electrically isolates the second input circuit CI2 and the second output circuit CO2. When the AC power is supplied from the second input circuit CI2, the isolation transformer TR2 outputs the AC power to the second output circuit CO2.

The second output circuit CO2 is a circuit on a secondary side in the second power supply circuit EP2. The second output circuit CO2 includes a not-shown rectifier and a not-shown smoothing circuit and converts the AC power supplied from the isolation transformer TR2 into DC power. The second output circuit CO2 includes two output terminals, that is, an output terminal CP2 and an output terminal CN2. The output terminal CP2 is an output terminal on a high-potential side in the second output circuit CO2. The output terminal CN2 is an output terminal on a low-potential side in the second output circuit CO2.

When the AC power is supplied from the isolation transformer TR2, the second output circuit CO2 converts the supplied AC power into DC power and causes a potential difference corresponding to the converted DC power between the output terminal CP2 and the output terminal CN2. At this point, potential applied to the output terminal CP2 is higher than potential applied to the output terminal CN2. As explained above, the second output circuit CO2 is electrically isolated from the second input circuit CI2 by the isolation transformer TR2. Therefore, the second output circuit CO2 can be regarded as a battery including the output terminal CP2 as a plus terminal and including the output terminal CN2 as a minus terminal. That is, when the second output circuit CO2 is regarded as the battery, the second input circuit CI2 is equivalent to an electromotive force of the second output circuit CO2, which is the battery. The second output circuit CO2 may be any circuit if the circuit is capable of causing a potential difference corresponding to the DC power supplied from the isolation transformer TR2 between the output terminal CP2 and the output terminal CN2.

The first power supply circuit EP1 and the second power supply circuit EP2 may have the same configuration or may have configurations different from each other. In the following explanation, as an example, the first power supply circuit EP1 and the second power supply circuit EP2 have the same configuration.

In the example shown in FIG. 2, the output terminal CP1 is connected to the output terminal CN2. This is equivalent to a configuration in which, when the first output circuit CO1 and the second output circuit CO2 are respectively regarded as the batteries as explained above, these two batteries are connected in series. Since the output terminal CP1 and the output terminal CN2 are connected in this way, in the power supply section EP, it is desirable that the output voltage and the rated output power value of the first power supply circuit EP1 and the output voltage and the rated output power value of the second power supply circuit EP2 are equal (an error of approximately ±5% is allowed). The rated output power value of the first power supply circuit EP1 refers to a power value in design determined in advance as a power value that the first power supply circuit EP1 is capable of steadily outputting. The rated output power value is, for example, 240 [W]. However, the rated output power value may be a power value smaller than 240 [W] or may be a power value larger than 240 [W]. The rated output power value of the second power supply circuit EP2 refers to a power value in design determined in advance as a power value that the second power supply circuit EP2 is capable of steadily outputting. The rated output power value is, for example, 240 [W]. However, the rated output power value may be a power value smaller than 240 [W] or may be a power value larger than 240 [W]. In this example, since the first power supply circuit EP1 and the second power supply circuit EP2 have the same configuration as explained above, the output voltage and the rated output power value of the first power supply circuit EP1 and the output voltage and the rated output power value of the second power supply circuit EP2 are equal. In the power supply section EP, the output voltage and the rated output power value of the first power supply circuit EP1 and the output voltage and the rated output power value of the second power supply circuit EP2 may be different from each other when some means can prevent a deficiency from occurring in both of the first power supply circuit EP1 and the second power supply circuit EP2. In the power supply section EP, the output voltage of the first power supply circuit EP1 may be equal to the output voltage of the second power supply circuit EP2 and the rated output power value of the first power supply circuit EP1 may be different from the rated output power value of the second power supply circuit EP2. In the power supply section EP, the output voltage of the first power supply circuit EP1 may be different from the output voltage of the second power supply circuit EP2 and the rated output power value of the first power supply circuit EP1 may be equal to the rated output power value of the second power supply circuit EP2. In the power supply section EP, when the first output circuit CO1 and the second output circuit CO2 are respectively regarded as the batteries, the first output circuit CO1 in the first power supply circuit EP1 and the second output circuit CO2 in the second power supply circuit EP2 may be connected such that these two batteries are connected in parallel.

Since the output terminal CP1 and the output terminal CN2 are connected in this way, the power supply section EP can apply, between the output terminal CN1 and the output terminal CP2, a voltage obtained by adding up the output voltage of the first power supply circuit EP1 and the output voltage of the second power supply circuit EP2. In other words, in the power supply section EP, a load factor of the power supply section EP is dispersed to each of the first power supply circuit EP1 and the second power supply circuit EP2 compared with when the same voltage as the voltage is supplied to the driving section M by one power supply circuit. Therefore, the power supply section EP can prevent a temperature rise of the power supply section EP compared with when the same voltage as the voltage is supplied to the driving section M by one power supply circuit. The temperature rise of the power supply section EP is further prevented as the first power supply circuit EP1 and the second power supply circuit EP2 are further separated because heat generated by the first power supply circuit EP1 and heat generated by the second power supply circuit EP2 are dispersed. That is, the control device 30 can supply desired electric power to the driving section M while preventing the temperature rise of the power supply section EP. In this example, a load factor of the power supply section EP at certain timing means a ratio of a power value of electric power supplied by the power supply section EP at the timing to the rated output power value of the power supply section EP.

The output terminal CP2 is connected to an input terminal on a high-potential side of input terminals of the power converting section IV. The output terminal CN1 is connected to an input terminal on a low-potential side of the input terminals of the power converting section IV. Consequently, the power supply section EP supplies DC power to the power converting section IV with the first output circuit CO1 and the second output circuit CO2 connected in series. That is, the power supply section EP supplies the DC power to the driving section M via the power converting section IV with the first output circuit CO1 and the second output circuit CO2 connected in series.

The power supply section EP is capable of supplying, in a predetermined time, electric power having a power value not less than first predetermined number times and not more than second predetermined number times of the rated output power value. The first predetermined number is, for example, 1.1. The first predetermined number may be any number if the number is smaller than the second predetermined number and larger than 1. More desirably, the first predetermined number is 1.5. Consequently, the robot 1 is capable of further educing performance of the driving section M during acceleration of the movable section A compared with when the first predetermined number is 1.1. The second predetermined number is, for example, four. The second predetermined number may be any number if the number is larger than the first predetermined number.

More specifically, the first power supply circuit EP1 is configured to be capable of supplying, in the predetermined time, electric power having a power value not less than first predetermined number times and not more than second predetermined number times of the rated output power value of the first power supply circuit EP1. The second power supply circuit EP2 is configured to be capable of supplying, in the predetermined time, electric power having a power value not less than first predetermined number times and not more than second predetermined number times of the rated output power value of the second power supply circuit EP2. In this example, the predetermined time is a certain short time in a period in which the robot 1 is operating. The predetermined time is, for example, approximately 0.5 seconds. The predetermined time may be a time shorter than 0.5 second or may be a time longer than 0.5 seconds. Consequently, the control device 30 can supply electric power necessary in starting to turn the driving section M in the robot 1 to the driving section M.

When DC power is supplied from the power supply section EP via the two input terminals of the power converting section IV, the power converting section IV converts the DC power supplied from the power supply section EP into electric power supplied to the driving section M. When the driving section M is driven by DC power, the electric power is the DC power. When the driving section M is driven by AC power, the electric power is the AC power. The power converting section IV supplies the converted electric power to the driving section M. The power converting section IV supplies the electric power to the driving section M according to switching control. The switching control is, for example, PWM control. The switching control may be other switching control instead of the PWM control. The power converting section IV is, for example, an inverter circuit. The power converting section IV may be, instead of the inverter circuit, another circuit capable of converting the DC power supplied from the power supply section EP into the electric power.

### Advantages of the Power Supply by the Power Supply Section EP

Advantages of the power supply by the power supply section EP in the control device 30 are explained while comparing a power supply section EPX (e.g., a power supply section in the past) different from the power supply section EP and the power supply section EP.

The power supply section EPX is a power supply section capable of supplying electric power to the driving section M with one power supply circuit. In the following explanation, as an example, the power supply section EPX includes, as the one power supply circuit, a third power supply circuit EP3, which is a power supply circuit having the same configuration as the first power supply circuit EP1.

An allowable load factor of the power supply section EPX decreases according to a temperature rise around the power supply section EPX. Therefore, the power supply section EPX is used while being cooled by one cooling method of natural air cooling for performing cooling with a naturally flowing air flow (an non-artificial air flow) and forced air cooling for performing cooling with an artificial air flow caused by a fan or the like. In this example, an allowable load factor of the power supply section EPX at certain timing means a ratio of a power value of electric power that the power supply section EPX can supply without causing a deficiency at the timing to the rated output power value of the power supply section EPX. The temperature around the power supply section EPX means the temperature of an air flow before touching the power supply section EPX to have higher temperature (i.e., an air flow cooled above the power supply section EPX) in an air flow circulating in a space in which the power supply section EPX is set.

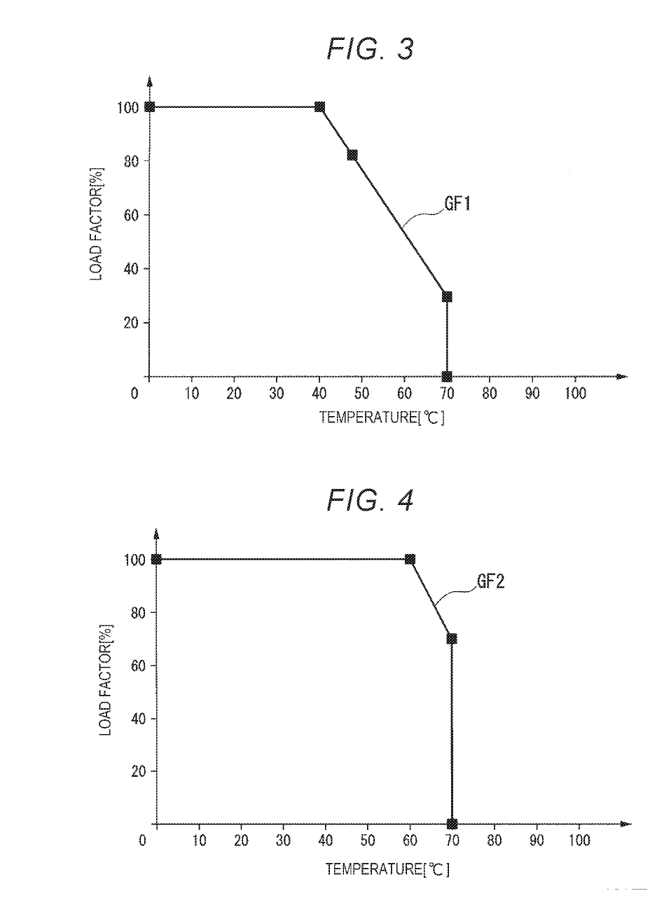

FIG. 3 is a diagram showing an example of a relation between a temperature change around the power supply section EPX and a change in the allowable load factor of the power supply section EPX at the time when the natural air cooling is adopted as the cooling method for the power supply section EPX. The horizontal axis of a graph shown in FIG. 3 indicates the temperature around the power supply section EPX. The vertical axis of the graph indicates a load factor of the power supply section EPX. In the graph, a change in the allowable load factor of the power supply section EPX in this case is represented by a polyline GF1. In this case, as indicated by the polyline GF1, the allowable load factor of the power supply section EPX starts to decrease when the temperature around the power supply section EPX exceeds approximately 40° C. In this case, the power supply section EPX cannot perform power supply (i.e., the allowable load factor of the power supply section EPX is 0%) when the temperature around the power supply section EPX reaches approximately 70° C.

FIG. 4 is a diagram showing an example of a relation between a temperature change around the power supply section EPX and a change in the allowable load factor of the power supply section EPX at the time when the forced air cooling is adopted as the cooling method for the power supply section EPX. The horizontal axis of a graph shown in FIG. 4 indicates the temperature of the power supply section EPX. The vertical axis of the graph shows a load factor of the power supply section EPX. In the graph, a change in the allowable load factor of the power supply section EPX in this case is represented by a polyline GF2. In this case, as indicated by the polyline GF2, the allowable load factor of the power supply section EPX starts to decrease when the temperature around the power supply section EPX exceeds approximately 60° C. In this case, the power supply section EPX cannot perform power supply (i.e., the allowable load factor of the power supply section EPX is 0%) when the temperature around the power supply section EPX reaches approximately 70° C.

It is seen by comparing FIG. 3 and FIG. 4 that the temperature around the power supply section EPX at which the allowable load factor of the power supply section EPX starts to decrease when the forced air cooling is adopted as the cooling method for the power supply section EPX is higher than the temperature around the power supply section EPX at which the allowable load factor of the power supply section EPX starts to decrease when the natural air cooling is adopted as the cooling method. This indicates that the robot 1 can be continuously operated without a rest for a longer period when the forced air cooling is adopted as the cooling method for the power supply section EXP than when the natural air cooling is adopted as the cooling method for the power supply section EPX. However, when the forced air cooling is adopted as the cooling method for the power supply section EPX, manufacturing cost of the control device 30 increases because an additional member such as a fan is necessary.

As opposed to such a power supply section EPX, the power supply section EP can prevent a time in which the robot 1 can be continuously operated without a rest from decreasing while reducing the manufacturing cost of the control device 30 by adopting the natural air cooling as the cooling method for the power supply section EP. As explained above, when causing the power supply section EP to perform power supply at a load factor of V[%], the load factor of the power supply section EP is dispersed to a load factor of the first power supply circuit EP1 and a load factor of the second power supply circuit EP2. In this case, the load factor of the first power supply circuit EP1 and the load factor of the second power supply circuit EP2 are respectively (V/2) [%]. In this example, as explained above, the power supply section EPX is the power supply section including the third power supply circuit EP3. That is, FIG. 3 is a diagram showing an example of a relation between a temperature change around the power supply section EPX and a change in the allowable load factor of the power supply section EPX at the time when the natural air cooling is adopted as the cooling method for the power supply section EPX and is also a diagram showing an example of a relation between a temperature change around the first power supply circuit EP1 and a change in an allowable load factor of the first power supply circuit EP1 at the time when the natural cooling is adopted as a cooling method for the first power supply circuit EP1. In this example, the configurations of the first power supply circuit EP1 and the second power supply circuit EP2 are the same. Therefore, FIG. 3 is also a diagram showing an example of a relation between a temperature change around the second power supply circuit EP2 and a change in an allowable load factor of the second power supply circuit EP2 at the time when the natural cooling is adopted as a cooling method for the second power supply circuit EP2. FIG. 4 is also a diagram showing an example of a relation between a temperature change around the first power supply circuit EP1 and a change in the allowable load factor of the first power supply circuit EP1 at the time when the forced air cooling is adopted as the cooling method for the first power supply circuit EP1. FIG. 4 is also a diagram showing an example of a relation between a temperature change around the second power supply circuit EP2 and a change in the allowable load factor of the second power supply circuit EP2 at the time when the forced air cooling is adopted as the cooling method for the second power supply circuit EP2. The temperature around the first power supply circuit EP1 means the temperature of an air flow before touching the first power supply circuit EP1 to have higher temperature (i.e., an air flow cooled above the first power supply circuit EP1) in an air flow circulating on the inner side of the second base B2. The temperature around the second power supply circuit EP2 means the temperature of an air flow before touching the second power supply circuit EP2 to have higher temperature (i.e., an air flow cooled above the second power supply circuit EP2) in an air flow circulating on the inner side of the second base B2.

For example, when causing the power supply section EP to perform power supply at a load factor of 60[%], the load factor of the first power supply circuit EP1 and the load factor of the second power supply circuit EP2 are respectively 30[%]. In this case, when the natural air cooling is adopted as the cooling method for the first power supply circuit EP1, as shown in FIG. 3, a temperature of the first power supply circuit EP1 at which the allowable load factor of the first power supply circuit EP1 starts to decrease is a temperature (approximately 69° C.) slightly lower than 70° C. In this case, when the forced air cooling is adopted as the cooling method for the first power supply circuit EP1, as shown in FIG. 4, the allowable load factor of the first power supply circuit EP1 does not decrease until the temperature of the first power supply circuit EP1 reaches 70° C. In this case, when the natural air cooling is adopted as the cooling method for the first power supply circuit EP1, as shown in FIG. 3, a temperature at which the allowable load factor of the second power supply circuit EP2 starts to decease is a temperature (approximately 69° C.) slightly lower than 70° C. In this case, when the forced air cooling is adopted as the cooling method for the second power supply circuit EP2, as shown in FIG. 4, the allowable load factor of the second power supply circuit EP2 does not decrease until the temperature of the second power supply circuit EP2 reaches 70° C. These facts indicate that, compared with the power supply section EPX, the power supply section EP can prevent a time in which the robot 1 can be continuously operated without a rest from decreasing while reducing the manufacturing cost of the control device 30 by adopting the natural air cooling as the cooling method for the power supply section EP.

Portions other than the power supply section EP and the power converting section IV in the control device explained above may be located in positions (e.g., positions on the inner side of the second base B2) other than positions on the inner side of the first base B1 among positions on the inside of the robot 1. In this example, the power supply section EP explained above may be located in a position (e.g., a position on the inner side of the first base B1) other than a position on the inner side of the second base B2 among the positions on the inside of the robot 1.

In FIG. 1 referred to in the above explanation, the first substrate BP1 and the second substrate BP2 on the inner side of the second base B2 are drawn as being disposed side by side along an X-axis direction in the robot coordinate system RC. However, this does not indicate an actual disposition relation between the first substrate BP1 and the second substrate BP2 on the inner side and only indicates that the first substrate BP1 and the second substrate BP2, which are the two separate substrates, are located on the inner side of the second base B2. A positional relation between the first substrate BP1 and the second substrate BP2 on the inner side of the second base B2 may be any positional relation realizable on the inner side of the second base B2. However, the first substrate BP1 and the second substrate BP2 are desirably separate.

As explained above, the robot 1 includes the driving section (in this example, the driving section M) and the power supply section (in this example, the power supply section EP) configured to supply electric power to the driving section. The power supply section includes the first power supply circuit (in this example, the first power supply circuit EP1) and the second power supply circuit (in this example, the second power supply circuit EP2). The power supply section is located on the inside of the robot (in this example, the inner side of the second base B2). Consequently, the robot 1 can prevent an increase in a setting area and prevent a temperature rise of the power supply section.

In the robot 1, the first input circuit (in this example, the first input circuit CI1) and the first output circuit (in this example, the first output circuit CO1) included in the first power supply circuit are electrically isolated. The second input circuit (in this example, the second input circuit CI2) and the second output circuit (in this example, the second output circuit CO2) included in the second power supply circuit are electrically isolated. The output terminal on the high-potential side (in this example, the output terminal CP1) of the output terminals of the first output circuit and the output terminal on the low-potential side (in this example, the output terminal CN2) of the output terminals of the second output circuit are connected. The power supply section applies, between the output terminal on the low-potential side (in this example, the output terminal CN1) of the output terminals of the first output circuit and the output terminal on the high-potential side (in this example, the output terminal CP2) of the output terminals of the second output circuit, a voltage obtained by adding up an output voltage of the first output circuit and an output voltage of the second output circuit. Consequently, the robot 1 can supply desired electric power to the driving section while preventing a temperature rise of the power supply section.

In the robot 1, the rated output power value of the first power supply circuit is equal to the rated output power value of the second power supply circuit. Consequently, the robot 1 can supply electric power to the driving section with the first power supply circuit and the second power supply circuit while preventing a deficiency from occurring in at least one of the first power supply circuit and the second power supply circuit because of a difference between the rated output power values of the first power supply circuit and the second power supply circuit.

In the robot 1, the output voltage of the first power supply circuit is equal to the output voltage of the second power supply circuit. Consequently, the robot 1 can supply electric power to the driving section with the first power supply circuit and the second power supply circuit while preventing a deficiency from occurring in at least one of the first power supply circuit and the second power supply circuit because of a difference between the output voltages of the first power supply circuit and the second power supply circuit.

In the robot 1, at least one of the first input circuit and the second input circuit includes the harmonic current suppression circuit (in this example, the harmonic current suppression circuit HS1 or the harmonic current suppression circuit HS2). Consequently, the robot 1 can suppress noise that occurs in at least one of the first power supply circuit and the second power supply circuit.

The robot 1 includes the power converting section (in this example, the power converting section IV) configured to convert electric power supplied from the power supply section into electric power supplied to the driving section. Consequently, the robot 1 can drive the driving section with electric power supplied by both of the first power supply circuit and the second power supply circuit and converted by the power converting section.

In the robot 1, the power supply section is capable of supplying electric power having a power value not less than 1.1 times and not more than four times of the rated output power value. Consequently, the robot 1 can supply, to the driving section, electric power necessary when starting to turn the driving section in the robot 1.

The embodiment of the invention is explained in detail above with reference to the drawings. However, a specific configuration is not limited to the embodiment. The specific configuration may be, for example, changed, replaced, or deleted without departing from the spirit of the invention.

The entire disclosure of Japanese Patent Application No. 2017-222633, filed Nov. 20, 2017 is expressly incorporated by reference herein.

What is claimed is:

1. A robot comprising:
a motor; and
a power supply section configured to supply electric power to the motor, wherein
the power supply section includes a first power supply circuit and a second power supply circuit and is located on an inside of the robot.

2. The robot according to claim 1, wherein
a first input circuit and a first output circuit included in the first power supply circuit are electrically isolated,
a second input circuit and a second output circuit included in the second power supply circuit are electrically isolated,
an output terminal on a high-potential side of output terminals of the first output circuit and an output terminal on a low-potential side of output terminals of the second output circuit are connected, and
the power supply section applies, between an output terminal on a low-potential side of the output terminals of the first output circuit and an output terminal on a high-potential side of the output terminals of the second output circuit, a voltage obtained by adding up an output voltage of the first output circuit and an output voltage of the second output circuit.

3. The robot according to claim 2, wherein a rated output power value of the first power supply circuit is equal to a rated output power value of the second power supply circuit.

4. The robot according to claim 2, wherein an output voltage of the first power supply circuit is equal to an output voltage of the second power supply circuit.

5. The robot according to claim 2, wherein at least one of the first input circuit and the second input circuit includes a harmonic current suppression circuit.

6. The robot according to claim 1, further comprising an inverter circuit configured to convert electric power supplied from the power supply section into electric power supplied to the motor.

7. The robot according to claim 1, wherein the power supply section is capable of supplying, in a predetermined time, electric power having a power value not less than 1.1 times and not more than four times of a rated output power value.
